(19) United States
(12) Patent Application Publication
(10) Pub. No.: US 2017/0059115 A1
(43) Pub. Date: Mar. 2, 2017

(54) LED ARRAY ON PARTIALLY REFLECTIVE SUBSTRATE WITHIN DAM HAVING REFLECTIVE AND NON-REFLECTIVE REGIONS

(71) Applicants: Min Huang, Hillsboro, NH (US); Lawrence M. Rice, Hillsboro, NH (US)

(72) Inventors: Min Huang, Hillsboro, NH (US); Lawrence M. Rice, Hillsboro, NH (US)

(73) Assignee: OSRAM SYLVANIA INC., Danvers, MA (US)

(21) Appl. No.: 14/840,437

(22) Filed: Aug. 31, 2015

(51) Int. Cl. F21S 8/10

(52) U.S. Cl. CPC F21S 48/31; F21S 48/1154; F21S 48/1376; F21S 48/145; F21Y 2101/02; F21Y 2105/001

(57) ABSTRACT

A packaged light emitting device 100 that allows enhanced light cutoff in lighting applications to better control glare and optimize lumen output. Packaged device 100 includes both a reflective dam region 34 and a non-reflective dam region 36 to increase output of useful light while mitigating reflection of light that can cause glare. An array 4, preferably linear, of light-emitting diodes 3 is formed on printed circuit board (PCB) 1, and surrounded by dam 30 which bounds encapsulant 40. A first circuit board portion 20 of PCB upper surface 2 enclosed within dam 30 disposed forward of LED array 4 and adjoining non-reflective dam portion 36 is non-reflective, such as being black. A second circuit board portion 22 is reflective, such as being white. Packaged device 100 is suited for automotive headlights and fog lights.

### TECHNICAL FIELD

The present disclosure relates to light emitting devices that enhance light cutoff to prevent a significant or otherwise distracting amount of light from being cast into preceding or oncoming cars. More particularly, the present disclosure relates to automotive chip-on-board (COB) light emitting diode (LED) sources on a printed circuit hoard (PCB) that include both reflective and non-reflective darn regions to increase the output of useful light while eliminating or otherwise mitigating the reflection of light that can cause glare.

### BACKGROUND

LED devices including an LED chip that is mounted onto a flat substrate and encapsulated with material, such as silicone, are known. These devices may be generally referred to as “chip on board” (COB) devices.

In the field is known U.S. Pat. No. 8,247,827 (Helbing) disclosing, at col. 4, line 20, a dam 106 whose entire extent around LED 202 is either entirely a reflective dam 206 or a transparent (or “clear”) dam 208, but not both reflective and transparent portions simultaneously. In the case where dam 106 is entirely a reflective dam 206, it is made of a reflective material such as being opaque white formed by titanium dioxide filler in an epoxy or silicone. In the case of dam 106 being entirely a clear or transparent dam 208 it is made of epoxy or silicone without filler. A side-by-side comparison at FIG. 2 shows a dam 106 that is reflective (206) generates a narrow beam pattern 218, in contrast to a dam 102 that is transparent (208) which generates a wider beam 222. While the dam 106 shows a side comparison akin to a “split screen” view which may at first glance misleadingly suggest the dam contains both reflective and transparent portions, one of skill in the art understands from the entirety of Helbing's disclosure in context, e.g. at column 5, lines 20-35 and the overall two different radiation patterns 218, 222, that the entire dam 106 is either opaque reflective in its entirety or transparent in its entirety.

Various dams and encapsulent arrangements for LEDs are known in: U.S. Pat. No. 6,897,490 (Brunner); U.S. Pat. No. 8,044,128 (Sawada); U.S. Pat. No. 8,835,952 (Andrews); U.S. Pat. No. 6,489,637 (Sakamoto); U.S. Pat. No. 7,952,115 (Loh); U.S. Pat. No. 7,834,375 (Andrews); U.S. Pat. No. 7,365,371 (Andrews); U.S. Pat. No. 8,492,790 (Lin); U.S. Pat. No. 8,536,592 (Chang); U.S. Pat. No. 8,536,593 (Lo); and US Pat. Pubs. 2013/0312906 (Shiobara); 2013/0207130 (Reiherzer); 2013/0154130 (Peil); 2003/0062518 (Auch); 2008/0099139 (Miyoshi); 2012/0193647 (Andrews); 2005/0051782 (Negley); and in PCT Intl Application WO 2008/046583 (Schrank). A circuit board is shown in U.S. Pat. No. 7,201,497 (Weaver).

### BRIEF DESCRIPTION OF THE DRAWINGS

Reference should be made to the following detailed description, read in conjunction with the following figures, wherein like numerals represent like parts:

FIG. 1 schematically illustrates one example packaged light emitting device 100 including a circuit board with a chip on board (COB) configuration according to the present disclosure;

FIG. 2 schematically illustrates another example of the packaged device of FIG. 1, and illustrates example reflective and non-reflective features thereof in more detail, in accordance with an embodiment of the present disclosure;

FIG. 3 shows another example of the packaged device of FIG. 1, and illustrates a dam having a rectangular shape, in accordance with an embodiment of the present disclosure;

FIGS. 4-5 show the dam of FIG. 3 in isolation, and illustrate examples of reflective portions and non-reflective portions that collectively define the entire dam, in accordance with some embodiments of the present disclosure;

FIG. 6 shows an example cross-sectional view of the packaged device, in accordance with an embodiment of the present disclosure;

FIG. 7 schematically illustrates another example of the packaged device of FIG. 3 including reflective and non-reflective regions thereof;

FIG. 8 shows an example cross-sectional view taken along line A-A of the packaged device of FIG. 7, in accordance with an embodiment of the present disclosure;

FIG. 9 schematically illustrates another example of the packaged device of FIG. 1, and illustrates the packaged device including, a plurality LED devices arranged in a M×N array, in accordance with an embodiment of the present disclosure;

FIG. 10 shows an example reflector assembly having active optics and including a packaged device with reflective and non-reflective dam portions, in accordance with an embodiment of this disclosure; and

FIG. 11 shows an example internal reflector assembly including a packaged device having reflective and non-reflective portions, in accordance with an embodiment of this disclosure.

For a thorough understanding of the present disclosure, reference is made to the following detailed description, including the appended claims, in connection with the above-described drawings. Although the present disclosure is described in connection with exemplary embodiments, the disclosure is not intended to be limited to the specific forms set forth herein. It is understood that various omissions and substitutions of equivalents are contemplated as circumstances may suggest or render expedient. Also, it should be understood that the phraseology and terminology used herein is for the purpose of description and should not be regarded as limiting.

### DETAILED DESCRIPTION INCLUDING BEST MODE OF A PREFERRED EMBODIMENT

The present disclosure provides a packaged light emitting device that allows enhanced light cutoff in lighting applications that seek to control glare and optimize or otherwise improve lumen output during low-beam generation. To provide the enhanced light cutoff, the packaged device includes both reflective and non-reflective regions to increase the output of useful light while also eliminating or otherwise mitigating the reflection of light that can cause glare. The packaged light emitting device is formed by a single light-emitting diode (LED) or an array of light-emitting diodes (LEDs) disposed on a generally flat substrate, such as a printed circuit board (PCB), and surrounded by a dam to allow the introduction of a sealing material to encapsulate the array of LED devices. This arrangement is generally referred to as chip-on-board (COB), which has seen a steady rise in popularity in a host of applications. For instance, COB is particularly well suited in automotive lighting applications including headlights and fog lights. Thus the packaged device may be used in a host of applications which make use of LED COB devices including, for example, motor vehicles, highway lighting, street lighting, and other applications that benefit from wide-area light emitters.

As referred to herein, the term reflective generally refers to a surface that reflects at least a portion of incident visible light. On the other hand, a non-reflective surface generally refers to a surface that reflects relatively less incident visible light than the reflective surface through, for example, absorption, diffraction, or other properties that mitigate reflection of light. These terms are intended to include common, ordinary meaning, but should not be construed as necessarily an exact reflectivity. In any event, and for the purpose of providing some specific examples, the minimum reflectivity of a “reflective” surface includes a reflectivity value of at least 80% for visible wavelengths, if not more. In contrast, the maximum reflectivity value of a “non-reflective” surface is 10%, with a preference towards the reflectivity being between 1% and 9%.

It should be appreciated that a non-transparent surface is functionally different than a transparent surface in the context of light beam optics. That is, non-transparent surfaces can absorb photons and generally do not spread a light beam. In contrast, a transparent surface does spread a light beam. To this end, while reference is made to a black (non-transparent) and transparent surface, the resulting light beams produced therefrom, respectively, have different beam patterns.

In any event, the packaged device disclosed herein includes part of its surface being non-reflective (e.g., black or transparent), and the remaining portion being reflective (e.g., white). This is to maximize or otherwise increase the output of useful light and to minimize or otherwise decrease the reflection of the light that otherwise causes glare. The white area, while capturing photons that would otherwise be wasted, produces light at a lower intensity than the main image of a light beam. In order to effectively produce a low beam, high intensity is desirable close to the light/dark cutoff with little or no spillover of lower intensity. To provide this balance, there is a non-reflective (e.g., black or transparent) region along a top or bottom portion along the long-side of the packaged device that produces the light/dark cutoff, and a reflective (e.g., white) area on the opposite side to recover photons that would otherwise be wasted. In some cases, the line of demarcation between reflective and. non-reflective areas is at the base, or top, as the case may be, of the LED devices fixedly attached to an upper surface of the packaged device. Thus the ratio of surface area that is reflective versus non-reflective is configurable, depending on a desired beam configuration.

In more detail, dam material of the packaged device is used to form a desired lens in the LED COB process. Aspects and embodiments disclosed herein manifest an appreciation that an entirely reflective dam, such as a white dam, produces high luminous intensity in a produced beam. In addition, an entirely non-reflective dam, such as a black or transparent dam, reduces glare. Thus, an embodiment disclosed herein includes a darn having both a reflective region and a non-reflective region to provide enhanced light cutoff (e.g., to reduce glare) and optimize or otherwise improve lumen output during low-beam generation.

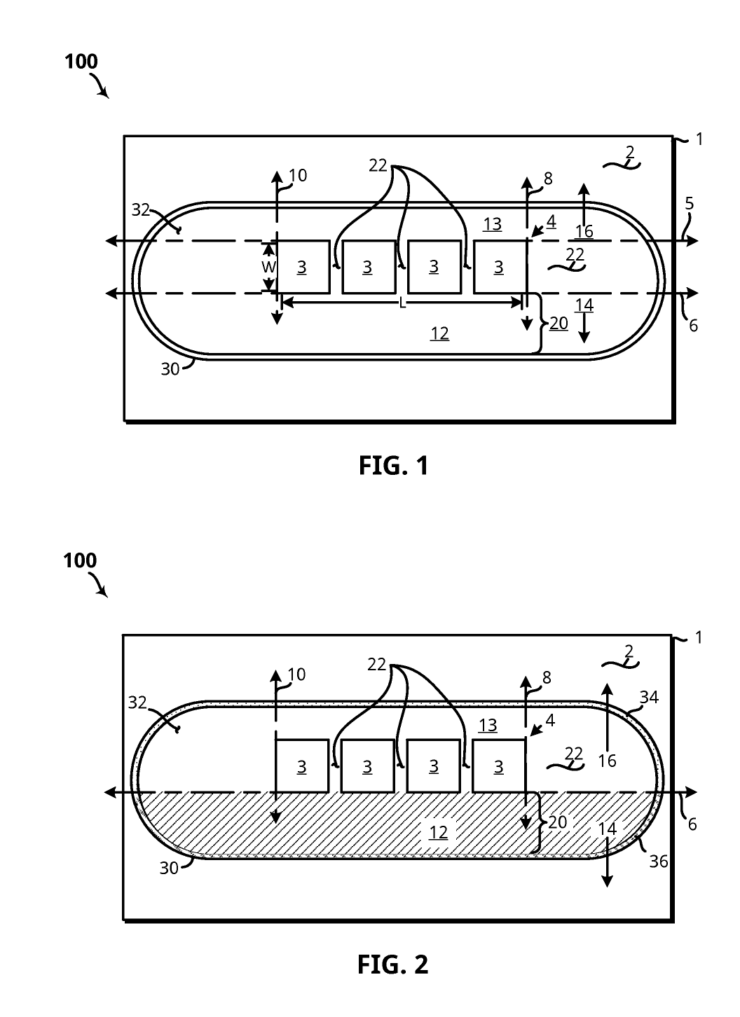

Turning now to FIG. 1, the packaged device 100 electrically couples a linear array of LEDs 4 to a lighting controller (not shown), such as provided in a motor vehicle headlamp, to provide controllable illumination. Note that while the specific examples provided herein reference motor vehicle lighting, the disclosure is not so limited and is merely an exemplary application.

In one aspect, the packaged device 100 includes a circuit board 1 comprising, for example, a printed circuit board (PCB) or other suitable substrate. For instance, the circuit board 1 can include a dielectric material such as, for example, glass fiber reinforced (fiberglass) resin, or a metal-core printed circuit board (MCPCB) or a ceramic substrate or ceramic heatsink, just to name a few. As shown, the circuit board 1 includes a circuit board upper surface 2, and a circuit board bottom surface (not shown) opposing the circuit board upper surface 2.

The circuit board 1 includes a plurality of solid-state light-emitting sources, such as light-emitting diodes (LEDs) 3, fixedly coupled to the circuit board upper surface 2, and forming an array 4, preferably a linear array of LEDs 4. The LEDs 3 may be attached via a feature of the circuit board 1, such as a ceramic sub-mount, or other suitable feature integrated or otherwise attached to the circuit board 1. The LEDs 3 are adjacent one another, and optionally and preferably arranged in a linear array 4. The LED linear array 4 is disposed along a first (forward) major long axis 6 that extends tangent to a long side of the linear array of LEDs 4 on a laterally forward direction 14 of the array. If the arrangement of LEDs 3 diverges from being a linear array 4, first long axis 6 is considered constructed tangent the forewardmost LED(s) in direction 14. In addition, the linear array of LEDs 4 also further define a rear major long axis 5 that also extends tangent to a long side of the linear array of LEDs 4 that is in parallel with the first major long axis 6. The linear array of LEDs 4 further defines two opposed lateral sides 8 and 10, respectively.

The packaged device 100 is not necessarily limited to four LEDs 3, as shown. For example, the packaged device 100 can include three (3), or more than four (4), LEDs 3, depending on a desired configuration. Moreover, while the linear array of LEDs 4 is shown in a generally center position of the packaged device 100, other locations will be apparent in light of this disclosure. The linear array of LEDs 4 can include uniform spacing between LEDs 3, or non-uniform spacing. Such spacing can include, for example, 1 millimeter or more or less, typically 0.1 mm in automotive lamps. The length L of the linear array of LEDs 4 can vary depending on, for instance, the size of each of the LEDs 3, the particular number of LEDs 3 within the linear array of LEDs 4, and desired component spacing configuration (e.g., uniform spacing, or non-uniform spacing). Likewise, the width W of the linear array of LEDs 4 can vary depending on similar factors, including the number of rows of LEDs 4, for example.

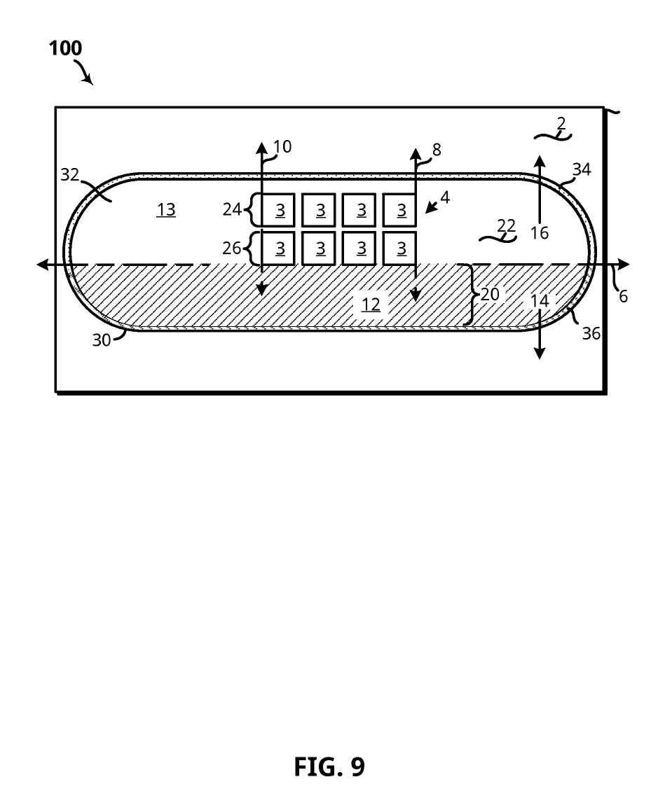

As shown in FIG. 9, the linear array of LEDs 4 can include multiple rows of LEDs 3 in a M×N array pattern. In this embodiment, the packaged device 100 includes first and second rows of LEDs 24 and 26, respectively. The first row of LEDs 24 includes all sides of each respective LED 3 being surrounded by the second circuit board portion 22, which includes a reflective surface. The second row of LEDs 26 includes at least one side of each respective LED 3 abutting or otherwise in close proximity of the first circuit board portion 20, which includes a non-reflective surface. The major long axis 6 extends tangent to a long side of the second row of LEDs 26 on a laterally forward direction 14 of the array. This arrangement is particularly well suited for applications that use the packaged device 100 to generate both low and high beams. For example, a high beam may be generated by the illumination of the first row of LEDs 24, or by illuminating a combination of the first row of LEDs 24 and the second row of LEDs 26. On the other hand, a low beam is generated by the illumination of only the second row of LEDs 26.

The circuit board 1 further includes an encapsulation-receiving region 32 on the circuit board upper surface 2, with the encapsulation-receiving region 32 surrounding the linear array of LEDs 4. The encapsulation-receiving region 32 on the circuit board upper surface 2 is configured to receive an encapsulent, such as silicone. A dam 30 is disposed on the circuit board upper surface 2, with the dam 30 surrounding, in spaced relation, the linear array of LEDs 4, and on an inner-region thereof, the encapsulation-receiving region 32. As discussed below, the dam 30 can be fixedly attached via a sealant or other suitable fastener that provides adhesion between the dam 30 and the circuit board upper surface 2. The dam 30 is configured to advantageously prevent the encapsulant (not shown) from flowing in regions of the circuit board upper surface 2 outside of the encapsulation-receiving region 32 while the encapsulant solidifies.

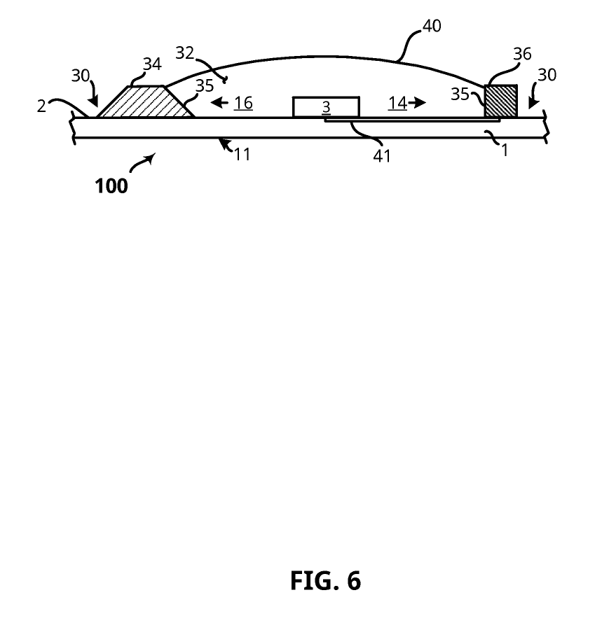

The dam 30 can have a thickness of at least 0.1 millimeters, although other thicknesses are also within the scope of this disclosure. Likewise, and as discussed below with regard to FIG. 6, the dam 30 can include an inwardly facing wall 35 with a pitch sufficient for containing the encapsulent in the encapsulation-receiving region 32 while the same solidifies.

Within the encapsulation-receiving region 32, the circuit board upper surface 2 further includes a first circuit board portion 20, with the first circuit board portion 20 located in a forward region 12 disposed in the laterally forward direction 14 of the first major long axis 6. As discussed below in greater detail, the first circuit board portion 20 is a non-reflective surface. The non-reflective first circuit board portion 20 can be generally flat, or it can be a raised surface. The first circuit board portion 20 can include a surface that is generally a black hue. Some such example materials providing such a non-reflective surface are discussed further below.

Also within the encapsulation-receiving region 32, the circuit board further includes a second circuit board portion 22 of the circuit board upper surface 2, with the second circuit board portion 22 located in a rear region 13 disposed in the laterally rearward direction 16. The second circuit board portion 22 of the circuit board upper surface 2 occupies an area of region 32 less the space occupied by the first circuit board portion 20 of the encapsulation-receiving region 32. As also discussed in greater detail below, the second circuit board portion 22 is a reflective surface. The reflective second circuit board portion 22 can be generally flat, or it can be a raised surface. Some such example materials providing such a reflective surface are discussed further below.

Now referring to FIG. 2, there is an example of the packaged device 100 of FIG. 1 schematically illustrated in further detail. Some features of the packaged device 100 shown in FIG. 2 have been omitted merely for clarity. As shown, the non reflective first circuit board portion 20 and the reflective second circuit board portion 22 generally conform to and are adjacent to a non-reflective dam portion 36, and a reflective dam portion 34, respectively. To this end, the first circuit board portion 20 can include a black or otherwise non-reflective surface to provide such a non-reflective, surface and match or approximate the corresponding non-reflective surface of the non-reflective dam. portion 36. Similarly, and on the other hand, the second circuit board portion 22 can include a white or otherwise reflective surface to match or approximate the corresponding reflective darn portion 34.

As shown, the non-reflective dam portion 36 is a region of the dam 30 disposed in the laterally forward direction 14 forward of an intersection of the first major long axis 6 and the darn 30. The non-reflective dam portion 36 and reflective dam portion 34 thus collectively define the entire dam 30. The reflective dam portion 34 occupies a remaining region of the dam 30 and is disposed in a rearward direction 16 behind the first major long axis 6. The reflective dam portion 34 surrounds the two opposed lateral sides 8, 10 and the rear long axis 5 of the linear array of LEDs 4. The forward region 12 of the circuit board upper surface 2 also includes non-reflective qualities, as indicated by shading thereon (FIG. 2). The rearward region 13 of the circuit board upper surface 2 includes the remaining area, and is indicated as reflective by an absence of shading.

Thus the first circuit board portion 20 can include a surface with a reflectivity that is less than or equal to the reflectivity of the non-reflective dam portion 36, and vice-versa. In some cases, this can include the first circuit board portion 20 comprising a surface with a black hue, and the non-reflective dam portion 36 having a transparent surface. Alternatively, non-reflective dam portion 36 can have a black hue. Similarly, the second circuit board portion 22 can include a surface with a reflectivity that is less than or equal to the reflectivity of the reflective dam portion 36, and vice-versa. However, the reflectivity of the surfaces of the first circuit board portion 20 and the non-reflective dam portion 36 are less than the reflectivity of the surfaces of the second circuit board portion 22 and the reflective dam portion 34.

The reflective dam portion 34 and non-reflective dam portion 36 can include a silicone damming material such as methyl rubber, phenyl rubber, other suitable material formed into desired dam geometries. For example, the non-reflective dam portion 36 can include silicone such as ShinEtsu X-35-396B or ShinEtsu Ker-6075-F, offered by Shin-Etsu Chemical Co., Ltd., mixed with carbon black pigments to form a black hue, or unmixed (e.g., transparent). On the other hand, the reflective dam portion 34 can include methyl rubber such as ShinEtsu Ker-2000Dam, also offered by Shin-Etsu Chemical Co., Ltd. A suitable material for a white reflective dam portion 36 is a silicone damming material with titanium oxide filler. In any such cases, the selected damming material may have a high viscosity to ensure the dam 30 does not flatten during curing. The exact material selection for reflective and non-reflective dam portions 34 and 36, respectively, is not particularly relevant to the present disclosure, but is important to the extent that the dam 30 have both reflective and non-reflective portions to achieve a desired light cutoff during operation of the packaged device 100.

While the first major long axis 6 shown in FIG. 2 provides a convenient and suitable point for delineating reflective and non-reflective, regions, this disclosure is not limited in this regard. For instance, the demarcation between reflective and non reflective regions may not be defined by a line that runs perpendicular to the the opposed lateral sides 8 and 10 as shown, and instead, may be defined by a generally sloped or diagonal line. Also, such demarcation can occur at a position that is above, or below, the position of the first major long axis 6 shown in FIG. 2 (e.g., located in a position favoring rearward direction 16, or favoring the forward direction 14). Such a position can bisect the linear array of LEDs 4, or at least occupy a position that cuts through a portion of the linear array of LEDs 4 versus stopping just short of or abutting the LEDs 3, as shown.

To this end, the reflective and non-reflective regions (including corresponding dam 30 portions) may occupy a generally equal area (e.g., 50/50) of the circuit board upper surface 2 bounded by dam 30, or be split unevenly between the two. For example, the first circuit board portion 20 may occupy 51% to 80%, or more, of the circuit board upper surface 2 bounded by dam 30. In other examples, the opposite may be true such that the second circuit board portion 22 occupies 51% to 80%, or more, of the circuit board upper surface 2 bounded by dam 30. In any event, during processing of the packaged device 100, the formation of reflective and non-reflective regions of both of the circuit board upper surface 2 and the dam 30, and the extent of surface space of circuit board 1 consumed thereby, can be configurable depending on a desired configuration.

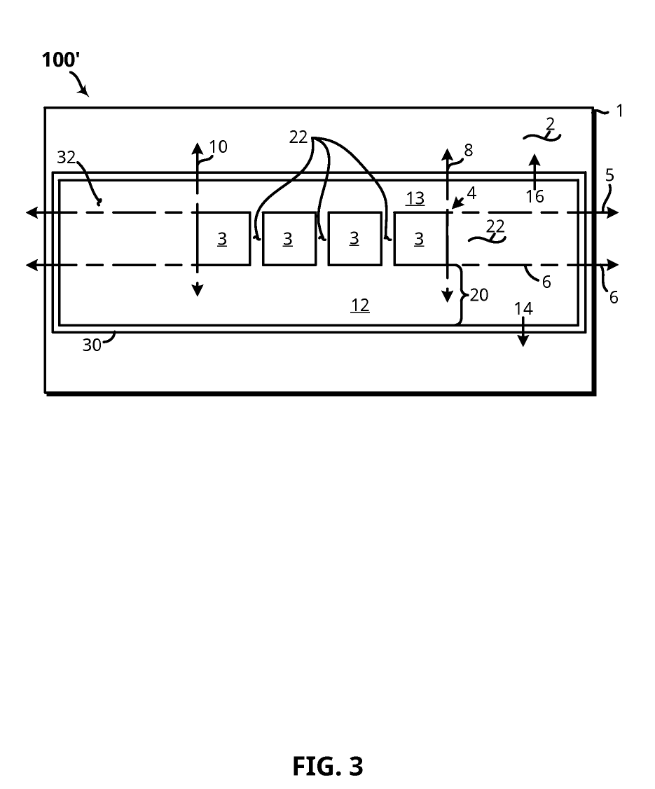

Referring now to FIG. 3, there is a schematic of a packaged device 100′, which is another example of the packaged device 100 of FIG. 1. The packaged device 100′ is identical to that of the packaged device 100, except for the dam 30 having a rectangular shape. Accordingly, the encapsulation-receiving region 32 includes a generally square boundary (e.g., right-angle corners) that conforms to and contacts dam 30. As should be appreciated, the shape of the dam 30 can include other regular or irregular geometric shapes, and the present disclosure should, not be construed as limited merely to the ones shown.

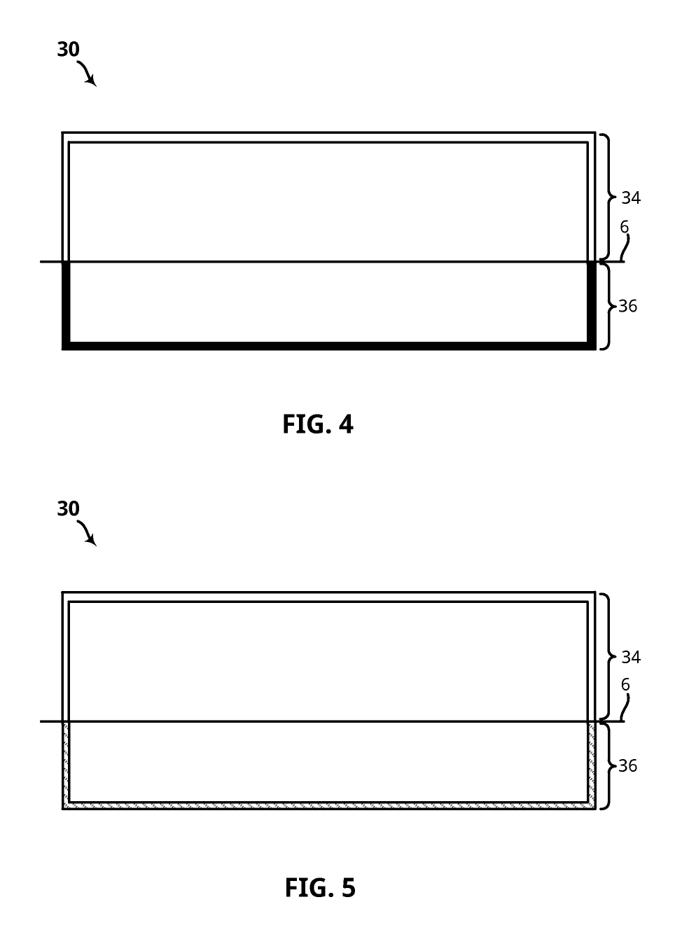

Referring now to FIG. 4, there is an example of the dam 30 in isolation, in accordance with an embodiment of the rectangular configuration of the packaged device 100′ of FIG. 3. As shown, the dam 30 includes a reflective dam portion 34 that has a surface that is white, mirrored, or otherwise suitably reflective. Conversely, the non-reflective dam portion 36 is black. The reflective and non-reflective dam portions 34 and 36, respectively, form the entirety of the darn 30.

Referring now to FIG. 5, there is another embodiment of the dam 30 in accordance with an embodiment of the packaged device 100′ of FIG. 3. As shown, the dam 30 includes a reflective dam portion 34 that is white, mirrored, or otherwise suitably reflective. Conversely, the non-reflective dam portion 36 comprises a generally transparent material. The reflective and non-reflective darn portions 34 and 36, respectively, form the entirety of the dam 30.

As should be appreciated in light of this disclosure, the shape of the dam 30, and dimensions thereof, are not limited to the particular embodiments illustrated herein, as previously discussed.

Referring now to FIG. 6, there is a cross-sectional view of the packaged device 100 in accordance with an embodiment of the present disclosure. Note that the embodiment shown in FIG. 6 is also applicable to the embodiments of packaged device 100′ shown in FIGS. 3-5. As shown, the packaged device 100 includes an encapsulant 40 disposed above the circuit board upper surface 2 forming a lens. As previously discussed, during processing of the COB the encapsulant 40 can be flowed and held in place by a well formed by the encapsulation-receiving region 32. In particular, containment of the free-flowing encapsulant 40 during process is achieved based on the inwardly facing walls 35 of dam 30 while the encapsulant 40 solidifies. The encapsulant 40 can include silicone, or other suitable material used in COB applications, as should be appreciated. Encapsulant 40 can, depending on surface tension and quantity of encapsulant 40, form an outwardly convex domed upper surface as shown in FIG. 6, or more preferably form a generally flat upper surface (not shown) that is parallel circuit board 1 and generally tangent to upper regions of both reflective dam portion 34 and non-reflective dam portion 36.

Also shown in the embodiment of FIG. 6 is a wire bond 41 that extends from each LED 3 of the linear array of LEDs 4 of FIG. 1 to the forward direction 14. Although shown as recessed in the circuit board 1, the wire bond 41 can include various configurations to allow a lighting system (e.g., a headlamp) to electrically couple to the packaged device 100. For example, the wire bond 41 can be routed over the dam 30, or on a backside surface 11 of the circuit board 1. In another example, the wire bond 41 can be at least partially routed on the circuit board upper surface 2. In this example, the wire bond 41 may extend through the dam 30 such as through an opening in dam 30. Note that the wire bond 41 may alternatively extend and be routed in the rearward direction 16.

In any event, the wire bond 41 may include or otherwise couple to electrical terminals (not shown) for forming such an electrical connection between a lighting system/assembly and the packaged device 100. These terminals may be located on the backside surface 11 of the circuit board 1, or at a position outside of the encapsulation-receiving region 32 adjacent the dam 30. Note that in some cases the wire bond 41 is routed through reflective regions, or alternatively, below the non-reflective regions, to reduce the potential of the wire bond 41 reflecting light incident to its surface in those areas of the packaged device 100 that are provided with a non-reflective surface. Stated more generally, the wire bond 41 is routed in such a way that it does not introduce a reflective surface in an otherwise non-reflective region of the packaged device 100. To this end, numerous routing options for wire bond 41 will be apparent in light of this disclosure.

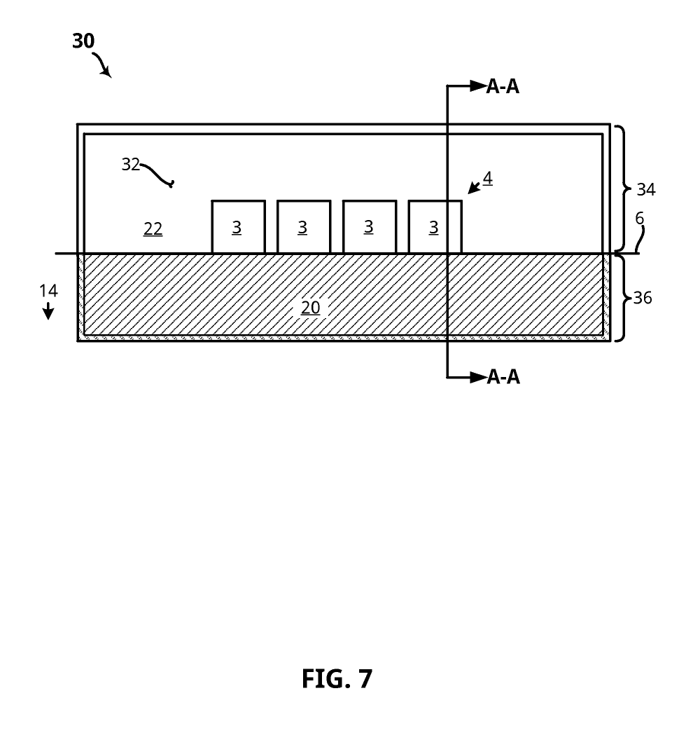

Now referring to FIG. 7, there is a schematic view illustrating the packaged device 100′ of FIG. 3. As shown, the encapsulation-receiving region 32 includes the first circuit board portion 20 being a non-reflective region, as indicated by shading thereon, and bounded by the non-reflective dam portion 36. In an embodiment, any region of the circuit board 1 positioned in the forward direction 14, including the inwardly facing wall 35 of dam 30, can receive light emitted by the linear array of LEDs 4. For this reason, the first circuit board portion 20 is non-reflective to allow the packaged device 100′ to produce a beam with minimized or otherwise reduced glare. This aids in producing the light/dark cutoff, as previously discussed.

Also as shown, the encapsulation-receiving region 32 includes the second circuit board portion 22 being a reflective region, as indicated by an absence of shading thereon, and is bounded by the reflective dam portion 34. The second circuit board portion 22 can be white, or include a mirrored finish such as an aluminized surface. In any event, this reflective region allows the packaged device 100′ to recover photons that would otherwise be wasted, as previously discussed.

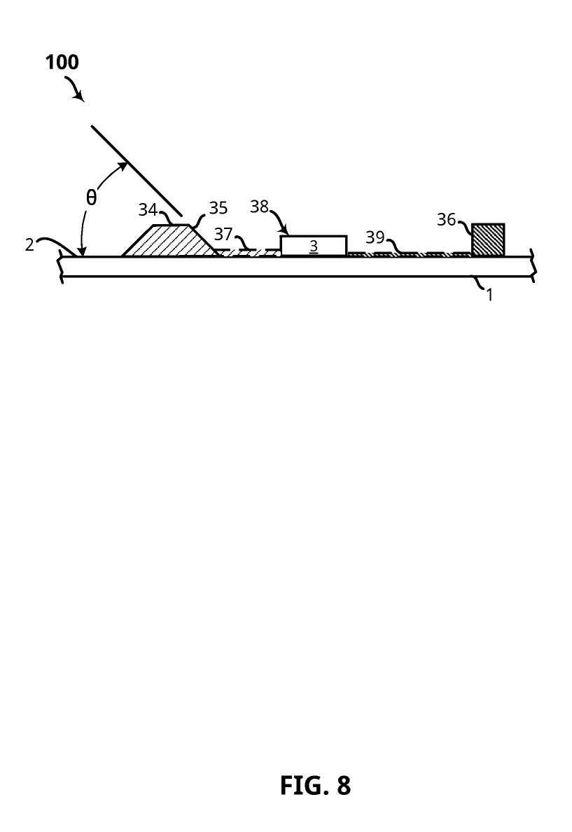

Referring now to FIG. 8, there is a cross-sectional view of the packaged device 100 taken along line A-A of FIG. 7. As shown, the reflective dam portion 34 includes a portion of the inwardly facing wall 35 of dam 30 sloped at angle θ relative to the circuit board 1. The preferred angle θ is less than 90 degrees, and in particular, at approximately 45 degrees, ±10 degrees. It is preferred that only reflective dam portion 34 is sloped at an angle θ less than 90 degrees, whereas it is preferred that non-reflective dam portion 36 not be sloped relative to circuit board 1 but rather be substantially perpendicular to circuit board upper surface 2. FIG. 6 likewise shows reflective dam portion 34 sloped at an angle as in FIG. 8, but omits the dimension lines for angle θ.

Also shown is an optional raised reflective surface 37 adjacent the reflective dam portion 34. The implementation of wall 35 at reflective dam portion 34 as a sloping wall (FIGS. 6, 8) is a feature independent of the presence of optional raised surfaces 37, 39. The optional raised reflective surface 37 can include a material such as titanium dioxide (TiO2). Whereas a thixotropic silicone is preferably used to define a boundary footprint of reflective dam portion 34, in some cases silicone with low viscosity is used to allow the raised reflective surface 37 to evenly spread from the reflective dam portion 34 to the LED(s) 3. Alternatively, the second circuit board portion 22 can include a coating of highly-reflected material such as, for example, gold (Ag) or aluminum (Al) without the optional raised reflective surface 37. As will be appreciated in light of this disclosure, other suitable materials that provide a reflective surface may be utilized. The optional raised reflective surface 37 can extend up to an upper surface 38 of the LED(s) 3. This is particularly advantageous when, for instance, an LED is configured to emit light via its sides. The packaged device 100 can further include an optional raised non-reflective surface 39 that extends from the LED(s) 3 to the non-reflective dam portion 36. This optional raised non-reflective surface 39 can include silicone with carbon particles (e.g., a black hued surface), as previously discussed. This material may also be low viscosity to spread evenly between the non-reflective dam portion 36 and the LED(s) 3.

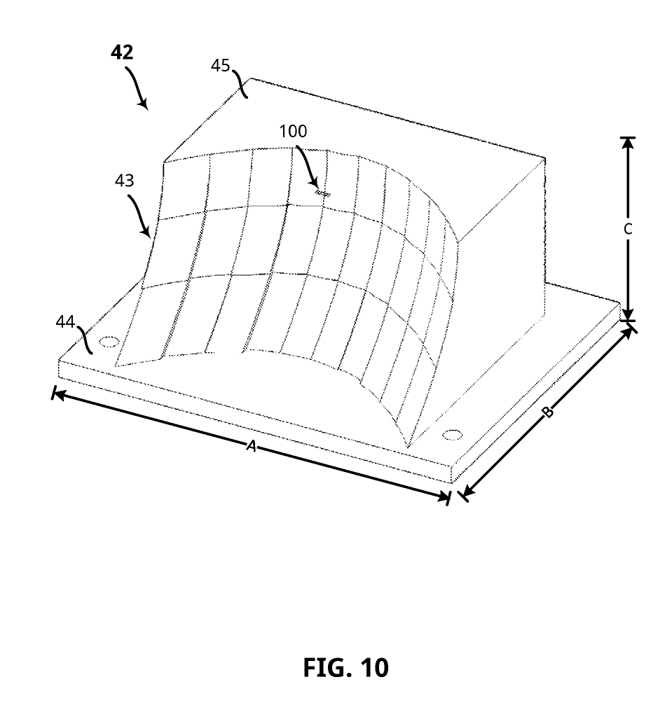

Referring to FIG. 10, there is an example reflector assembly 42 having active optics 43 and electrically coupling to the packaged device 100, in accordance with an embodiment of this disclosure. The example reflector includes a base 44, a body 45, and active optics 43. The reflector assembly 42 includes a length (A) of 120 mm, a width (B) of 120 mm, and a height (C) of 66 mm. To this end, and as shown, the packaged device 100 includes a dimension of 5 mm or less for its relative length, width and height. Note that the packaged device 100 can include additional area by virtue of the circuit board 1, but is omitted merely to show relative position within the reflector assembly 42. In some cases, the active optics 43 are formed by aluminizing a portion of the body 45. The base 44 is non-reflective (e.g., non-aluminized) to avoid reflecting portions of a produced beam. The packaged device 100 is configured to point towards the active optics 43 such that light is emitted directly thereto. This can include the packaged device 100 being positioned relative to the base 44 at an angle of 20 to 30 degrees, for example. The active optics 43 are configured such that a generated beam includes a low-beam with a desired pattern, and with a suitable light/dark cutoff, that can vary based on a desired application.

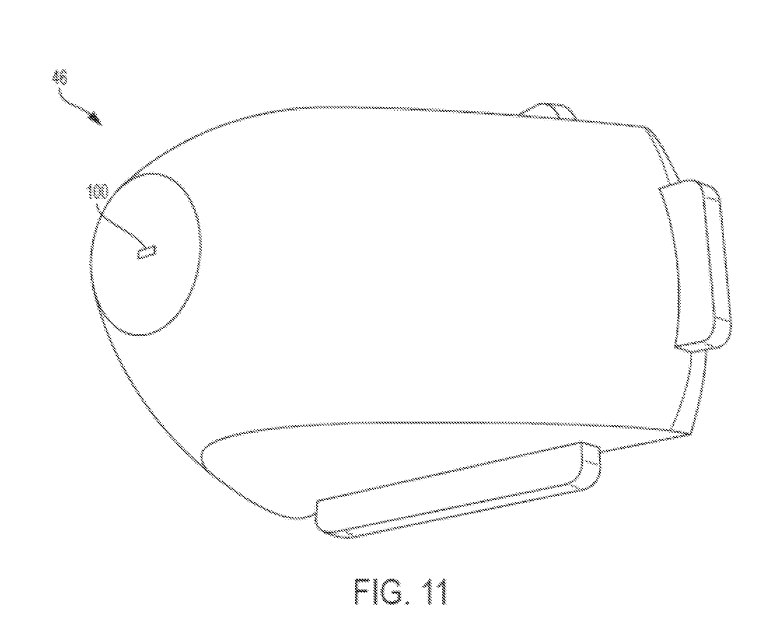

Referring to FIG. 11, there is an example internal reflector assembly 46 including the packaged device 100 having reflective and non-reflective portions, in accordance with an embodiment of this disclosure.

In some cases processing of the packaged device 100 is as follows. First, a die is attached and the wire bond 41 is formed on the circuit board 1. Next, a liquid silicone white material (e.g., TiO2 loaded) is poured as a first dam material to form the reflective dam portion 34, then a second black (or transparent, as the case may be) silicone dam material, for instance, is poured to form the non-reflective dam portion 36. During this stage, the first and second materials remain in a semi-liquid state and are suitably viscous such that they do not generally intermix but instead retain the shape of the dam, as governed by the die. In some cases the packaged device 100 is placed into an oven to aid in curing the dam materials. Note that it may be desirable to have a small width for dam 30 to maintain a comparatively large height/pitch, at a constant height, in order to create a mechanically small package. The transparent dam material benefits from having a high viscosity, so it doesn't flatten out during process.

While several embodiments of the present disclosure have been described and illustrated herein, those of ordinary skill in the art will readily envision a variety of other means and/or structures for performing the functions and/or obtaining the results and/or one or more of the advantages described herein, and each of such variations and/or modifications is deemed to be within the scope of the present disclosure. More generally, those skilled in the art will readily appreciate that all parameters, dimensions, materials, and configurations described herein are meant to be exemplary and that the actual parameters, dimensions, materials, and/or configurations will depend upon the specific application or applications for which the teachings of the present disclosure is/are used.

Those skilled in the art will recognize, or be able to ascertain using no more than routine experimentation, many equivalents to the specific embodiments of the disclosure described herein. It is, therefore, to be understood that the foregoing embodiments are presented by way of example only and that, within the scope of the appended claims and equivalents thereto, the disclosure may be practiced otherwise than as specifically described and claimed. The present disclosure is directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the scope of the present disclosure.

All definitions, as defined and used herein, should be understood to control over dictionary definitions, definitions in documents incorporated by reference, and/or ordinary meanings of the defined terms.

The indefinite articles “a” and “an,” as used herein in the specification and in the claims, unless clearly indicated to the contrary, are understood to mean “at least one.”

The phrase “and/or,” as used herein in the specification and in the claims, should be understood to mean “either or both” of the elements so conjoined, i.e., elements that are conjunctively present in some cases and disjunctively present in other cases. Other elements may optionally be present other than the elements specifically identified by the “and/or” clause, whether related or unrelated to those elements specifically identified, unless clearly indicated to the contrary.

The phrase “comprising” in the claims hereinbelow, or in describing features of an embodiment in the written description hereinabove, includes the case of only the features recited in the claim or described in an exemplary embodiment, as well as the case of features in addition to those recited in the claim or described in an embodiment.

An abstract is submitted herewith. It is pointed out that this abstract is being provided to comply with the rule requiring an abstract that will allow examiners and other searchers to quickly ascertain the general subject matter of the technical disclosure. It is submitted with the understanding that it will not be used to interpret or limit the scope or meaning of the claims, as set forth in the rules of the U.S. Patent and Trademark Office.

The following non-limiting reference numerals are used in the specification:
1 circuit board
2 circuit board upper surface
3 LED
4 array of LEDs
5 rear major long axis
6 first (forward) major long axis
8, 10 opposed lateral sides
11 circuit board backside surface
12 forward region
13 rearward region
14 laterally forward direction
16 laterally rearward direction
20 first circuit board portion
22 second circuit board portion
24 first row of LEDs
26 second row of LEDs
30 dam
32 encapsulation-receiving region
34 reflective dam portion
35 inwardly facing wall of dam 34
36 non-reflective dam portion
37 optional raised reflective surface
39 optional raised non-reflective surface
40 encapsulant
41 wire bond
42 a reflector assembly
43 active optics of the reflector assembly 42
44 base of the reflector assembly 42
45 a body of the reflector assembly 42
46 internal reflector assembly
100 packaged light emitting device
100′ packaged light emitting device
θ angle between face of reflective dam and circuit board
L length of the linear array of LEDs 4
W width of the linear array of LEDS 4

What is claimed is:

1. A packaged light emitting device (100) comprising:
a circuit board (1) having an upper surface (2);
a plurality of light-emitting diodes (LEDs) (3) coupled to the circuit board upper surface (2) and arrayed in an LED array (4), said array (4) defining a first major long axis (6) extending tangent to a long side of the array (4) on a laterally forward direction (14) of the array, said array further defining two opposed lateral sides (8, 10);
a dam (30) disposed on the circuit board surrounding, in spaced relation, the LED array (4), the dam (30) bounding, on an inner region thereof, an encapsulation-receiving region (32);
a first circuit board portion (20) being the circuit board upper surface (2) disposed within the encapsulation-receiving region (32) and located in a forward region (12) disposed in the laterally forward direction (14) of the first major long axis (6), wherein the first circuit board portion (20) is non-reflective;
a second circuit board portion (22) being the portion of the circuit board upper surface (2) within the encapsulation-receiving region (32) less the first circuit board portion (20), wherein the second circuit board portion (22) is reflective;
the dam (30) defining a reflective dam portion (34) and a non-reflective dam portion (36), the reflective dam portion (34) and the non-reflective dam portion (36) collectively defining an entirety of the dam (30);
the non-reflective dam portion (36) being a region of the dam (30) disposed in the laterally forward direction (14) forward of an intersection of the first major long axis (6) and the dam (30); and
the reflective dam portion (34) occupying a remainder region of the dam (30) and disposed in a rearward direction (16) behind the first major long axis (6).

2. The packaged light emitting device (100) of claim 1, wherein the reflective dam portion (34) surrounds the two opposed lateral sides (8, 10) and a rear long major axis (5) of the array (4).

3. The packaged light emitting device (100) of claim 1, wherein the first circuit board portion (20) is black.

4. The packaged light emitting device (100) of claim 1, wherein the second circuit board portion (22) is white.

5. The packaged light emitting device (100) of claim 3, wherein the second circuit board portion (22) is white.

6. The packaged light emitting device (100) of claim 1, wherein the non-reflective dam portion (36) is transparent and/or black.

7. The packaged light emitting device (100) of claim 6, wherein the non-reflective dam portion (36) is transparent.

8. The packaged light emitting device (100) of claim 6, wherein the non-reflective dam portion (36) is black.

9. The packaged light emitting device (100) of claim 1, wherein the reflective dam portion (34) is white.

10. The packaged light emitting device (100) of claim 1, wherein
the first circuit board portion (20) is black;
the second circuit board portion (22) is white;
the reflective dam portion (34) is white; and
the non-reflective dam portion (36) is transparent and/or black.

11. The packaged light emitting device (100) of claim 1, wherein an inwardly facing wall (35) of the reflective dam portion (34) that faces the array (4) defines an included angle (θ) relative the circuit board upper surface (2) that is less than 90 degrees.

12. The packaged light emitting device (100) of claim 11, wherein the included angle (θ) is within a range of about 35 degrees to about 55 degrees.

13. The packaged light emitting device (100) of claim 11, wherein the included angle (θ) is about 45 degrees.

14. The packaged light emitting device (100) of claim 1, wherein the LED array (4) comprises an M×N array having at least two rows, with each row having at least two LEDs.

15. The packaged light emitting device (100) of claim 1, wherein the first circuit board portion (20) comprises a raised non-reflective surface (39).

16. The packaged light emitting device (100) of claim 1, wherein the second circuit board portion (22) comprises a raised reflective surface (37).

17. The packaged light emitting device (100) of claim 1, wherein the first circuit board portion (20) includes a reflectivity value of less than 10%.

18. The packaged light emitting device (100) of claim 1, wherein the second circuit board portion (22) includes a reflectivity value equal to or greater than 80%.

19. The packaged light emitting device (100) of claim 1, further comprising a wire bond (41) extending from the LED array (4) to an electrical terminal.

20. A reflector assembly (45) comprising the packaged light emitting device (100) of claim 1.
